(19) United States
(12) Patent Application Publication
(10) Pub. No.: US 2003/0056961 A1
(43) Pub. Date: Mar. 27, 2003

(54) Plant removing or weeding device

(76) Inventor: Philip Clinton Jones, Sequim, WA (US)

Correspondence Address: LAW OFFICE OF WILLIAM L. KLIMA, P.C., P.O. Box 2855, Stafford, VA, 22555-2855, US

(21) Appl. No.: 10/232,409

(22) Filed: Sep. 3, 2002

Related U.S. Application Data
(63) Continuation-in-part of application No. 09/823,539, filed on Apr. 2, 2001, now abandoned.

(51) Int. Cl. A01B 1/00

(52) U.S. Cl. 172/371

(57) ABSTRACT

A plant removing or weeding device including a handle portion, a blade portion and preferably a cross member configured to function as a foot bar portion and fulcrum. The blade portion is configured to penetrate and divide the soil, and the blade portion is pivoted upwardly by pulling the handle towards the user and pushing downwardly to lift the plant and root from the soil.

### RELATED APPLICATION

This is a continuation-in-part of U.S. Patent Application entitled “Weeder Tool”, Ser. No. 09/823,539, filed on Apr. 2, 2001, fully incorporated herein by reference.

### FIELD OF THE INVENTION

The present invention is directed to a plant removing or weeding device configured to remove plants, in particular weeds from lawns, gardens and other plantings.

### BACKGROUND OF THE INVENTION

There exists many tools and devices for plant removing or weeding. Some of these devices are configured to cut plants free of the root by pushing a blade horizontally on or below the surface of the ground. Others are designed to grip the plant to pull it out of the soil while others are designed to dig up the plant.

Many of the prior art tools or devices tend to leave a substantial portion of the root in the ground potentially allowing the weed to regrow and become a reoccurring nuisance.

The plant removing or weeding device according to the present invention is configured to remove the entire or substantially the entire root from the ground by loosening the soil and then lifting the root out from beneath the ground to allow effective plant removal or weeding of the lawns, gardens, and other plantings more so than the conventional plant weeding devices.

### SUMMARY OF THE INVENTION

A first object of the present invention is to provide an improved plant removing or weeding device.

A second object of the present invention is to provide a plant removing or weeding device configured to substantially remove an entire root of the plant to prevent regrowth.

A third object of the present invention is to provide a plant removing or weeding device including a handle portion connected to an elongated-shaped blade portion, the blade portion being substantially bent along a longitudinal axis of the blade portion, the blade portion have a spade tip portion.

A fourth object of the present invention is to provide a plant removing or weeding device including a handle portion connected to an elongated-shaped blade portion, the blade portion having a V-shaped transverse cross-sectional shape in combination with a spade tip portion.

A fifth object of the present invention is to provide a plant removing or weeding device including a handle portion connected to an elongated-shaped double faced blade portion, the blade portion being a reversed bent blade configured with the leading (convex) edge aimed at the plant and the concave side facing away from a plant being removed.

The present invention is directed to a plant removing or weeding device configured for removing plants, weeds, or other vegetation from soil or other growth substrate. The device can configured as a hand tool for manual operation, or potentially can be coupled or integrated into powered or automatic equipment or machinery, in particular a powered garden or farm type equipment to provide partial or full automation. The hand tool embodiment of the present invention includes a handle portion connected to an elongated-shaped blade portion. In a powered or automatic machine type implementation, the machine would be directly or indirectly coupled to the elongated-shaped blade portion of the device according to the present invention.

A preferred embodiment of the plant removing or weeding device includes a handle portion connected to a blade portion. The blade portion is preferably an elongated-shaped blade portion. More preferably, the elongated-shaped blade portion is bent along a longitudinal axis of the blade portion to create two faces and to greatly increase the bending strength of the blade portion. Alternatively, a reinforcing web or rib can be added to a flat or curved plate (e.g. steel plate) to reinforce the strength of the plate for penetrating the soil and then lifting up the plant during removal.

The blade can be made of metal, steel, chromed plated steel, stainless steel, metal alloy, other structurally suitable metal or metal composites, plastic, molded plastic, fiberglass, Kevlar, graphite, plastic composite, plastic/metal composite, aluminum, or other suitable materials having sufficient strength, durability and wear properties for the particular application of the plant or weed removing device according to the present invention.

The blade portion can be fabricated by bending sheet metal, forging metal, pressing metal, extruding metal, rolling metal, hydraulically shaping metal, machining metal, or other suitable metal fabrication technique. In a preferred embodiment, the blade is made from existing metal stock such as rolled, extruded or bent metal stock. For example, the metal stock can be a V-shaped transverse cross-sectional shaped stock material, such as readily available angle iron or steel. In the case of angle iron, a section of angle iron is cut from a stock piece of angle iron to length, and then further worked, for example, by drilling, grinding and/or sharpening operations to form the finished blade portion.

The handle portion of the plant removing or weeding device can be made of a wide variety of materials, including but not limited to wood, plastic, fiberglass, Kevlar, graphite, plastic composite, metal, aluminum, steel, metal/plastic composite, or other suitable materials for such application. In a preferred embodiment, the handle is provided with a handgrip, for example, a handgrip connected by a yoke to an upper end of the handle portion. The handle portion can be constructed to be a single piece with the blade portion, or can be constructed as separate components and assembled together. For example, the handle portion can be received within a sleeve of the blade portion and/or be connected by fasteners such as bolts, rivets, or other suitable fasteners to the blade portion.

In a preferred embodiment, the plant removing or weeding device according to the present invention is provided with at least one fulcrum to provide a mechanical advantage to the user during manual use thereof Specifically, a fulcrum can be added to a lower portion of the device, for example, a cross member can be connected to a lower portion of the handle portion, or more preferably can be connected to the blade portion (e.g. metal cross member can be welded to the metal blade portion to provide significant strength and durability). The fulcrum is preferably configured to make contact with the ground, at or below the surface of the ground, after the blade portion has been driven into the ground by the user's foot, so that when the user then pulls the handle towards himself or herself, the buried blade portion pivots upwardly. The fulcrum(s) is preferably located on one or both sides of the blade portion so as to make contact with the ground when the blade portion is driven into the ground, or when the handle portion is then pushed downwardly. In this manner, the fulcrum can effectively act as a pivot with the ground supporting the fulcrum at that particular location along the length of the plant removing or weeding device. For example, the blade portion can be-made from a piece of angle iron, and the fulcrum can be made from another piece of angle iron welded to the back side of the blade portion, and oriented transversely therewith.

In a preferred embodiment, the plant removing or weeding device is provided with a foot actuator, such as a foot pedal, support, peg, edge or other configuration to allow a user to use one or both feet to force the blade portion of the device into the ground. In a more preferred embodiment, the fulcrum described above is also utilized or functions as a set of one or two foot pegs for driving the blade portion into the soil by the user's feet.

The blade portion is preferably bent, more preferably substantially bent, again to increase the bending strength of the blade portion so that the blade portion does not bend when driven into the soil, and when the handle portion is pushed down forcing the blade portion upwardly within the soil rotating at the fulcrum point (foot pegs or crossbar) along the length of the device. The blade is preferably bent along a longitudinal axis of the blade portion, however, the bending can be made somewhat off the central longitudinal axis of the blade portion while still sufficiently reinforcing the blade portion. The blade portion can be bent once so as to define two side-by-side blade portions, or can be bent a multiple number of times to provide three or more separate side-by-side blade portions connected together.

The term “bent” or “bend” means the resulting shape of the blade portion as opposed to the method of making, however, the blade portion according to the present invention can be made by a bending operation, likewise an extruding operation, forging operation, welding operation, metal cutting operation, milling operation or other suitable methods of making. The blade portion is preferably a reversed bent blade portion so that when the blade portion is driven into the earth at or near the roots of a plant to be removed, the blade portion is oriented to be opened away from the roots of the plant as opposed to facing the plant (i.e. in the manner like a shovel would be oriented). The reverse orientation of the blade portion may not be meaningful when utilizing a substantially straight handle portion, which would allow reorientation with the open face facing the plant or facing away from the plant, however is meaningful particularly in embodiments where the handle is not straight (e.g. asymmetric, bent, curved, angled, or otherwise off axis with a central longitudinal of the blade portion). In use, the blade portion is preferably oriented so that the open face or side of the blade is oriented away from the roots of the plant the opposite of a conventional shovel would operate.

In use, the plant removing or weeding device according to the present invention is positioned with the tip portion of the device approximately two inches from the base of the plant to be removed. The user then forces the blade portion perpendicularly into the soil by applying downward force by body weight to the foot actuator portion of the device. When a sufficient length of the blade portion has penetrated into the soil, the user then pulls back and downwardly on the handle with his or her hand so that the buried blade portion of the device pivots upwardly breaking up and separating the soil, and then lifting and removing the plant from the soil. In embodiments of the device having a foot actuator, the user initially forces the handle portion downwardly, however, for hard or dry soil the user then utilizes one or both feet on the foot actuator to force the blade portion deep enough into the soil to be effective (i.e. preferably until the foot actuator makes contact with the ground). Then, the user pushes the handle down causing the buried blade portion to pivot upwardly breaking up the soil while forcing the roots of the plant and the plant itself upwardly out of the soil.

### BRIEF DESCRIPTION OF THE DRAWINGS

FIG. 1 is a perspective view of a plant removing or weeding device according to the present invention.

FIG. 2 is a front elevational view of the plant removing or weeding device, as shown in FIG. 1.

FIG. 3 is a cross-sectional view of the plant removing or weeding device, as indicated in FIG. 2.

FIG. 4 is a side elevational view of the plant removing or weeding device, as shown in FIG. 1.

FIG. 5 is a transverse cross-sectional view of the plant removing or weeding device as indicated in FIG. 4.

FIG. 6 is a rear side elevational view of the plant removing or weeding device, as shown in FIG. 1.

FIG. 7 is a transverse cross-sectional view of the plant removing or weeding device, as indicated in FIG. 6.

FIG. 8 is a bottom perspective view of the blade portion of the plant removing or weeding device, as shown in FIG. 1.

FIG. 9 is a bottom perspective view of another embodiment of the blade portion of a plant removing or weeding device according to the present invention.

FIG. 10 is a bottom perspective view of a further embodiment of the blade portion of a plant removing or weeding device according to the present invention.

FIG. 11 is a bottom edge view of an embodiment of the blade portion of a plant removing or weeding device according to the present invention.

FIG. 12 is a bottom edge view of another embodiment of the blade portion of a plant removing or weeding device according to the present invention.

FIG. 13 is a bottom edge view of a further embodiment of the blade portion of a plant removing or weeding device according to the present invention.

FIG. 14 is a bottom edge view of another further embodiment of the blade portion of a plant removing or weeding device according to the present invention.

FIG. 15 is a bottom edge view of a still further embodiment of the blade portion of a plant removing or weeding device according to the present invention.

FIG. 16 is a bottom edge view of an even further embodiment of the blade portion of a plant removing or weeding device according to the present invention.

FIG. 17 is a bottom edge view of an even still further embodiment of the blade portion of a plant removing or weeding device according to the present invention.

FIG. 18 is a bottom edge view of another still further embodiment of the blade portion of a plant removing or weeding device according to the present invention.

FIG. 19 is a broken away rear elevational view of a tip portion of a blade portion of a plant removing or weeding device according to the present invention.

FIG. 20 is a broken away rear elevational view of another tip portion of a blade portion of a plant removing or weeding device according to the present invention.

FIG. 21 is a broken away rear elevational view of a further tip portion of a blade portion of a plant removing or weeding device according to the present invention.

FIG. 22 is a broken away rear elevational view of an even further tip portion of a blade portion of a plant removing or weeding device according to the present invention.

FIG. 23 is a diagrammatic perspective view of a person using the plant removing or weeding device according to the present invention showing the person forcing downwardly a blade portion of the device into the soil adjacent to the root of a plant.

FIG. 24 is a diagrammatic perspective view of a person using the plant removing or weeding device according to the present invention, and showing the person pivoting the blade portion of the device lifting the plant upwardly when pushing downwardly on the handle portion of the device.

FIG. 25 is a rear perspective view of another embodiment of the blade portion of the plant removing or weeding device according to the present invention without a handle portion connected thereto.

FIG. 26 is a rear perspective view of the blade portion shown in FIG. 25, with a handle portion connected thereto.

FIG. 27 is a rear perspective view of a further embodiment of the blade portion of the plant removing or weeding device according to the present invention without a handle portion connected thereto.

FIG. 28 is a rear perspective view of the blade portion shown in FIG. 27, with a handle portion connected thereto.

### DETAILED DESCRIPTION OF THE PREFERRED EMBODIMENT

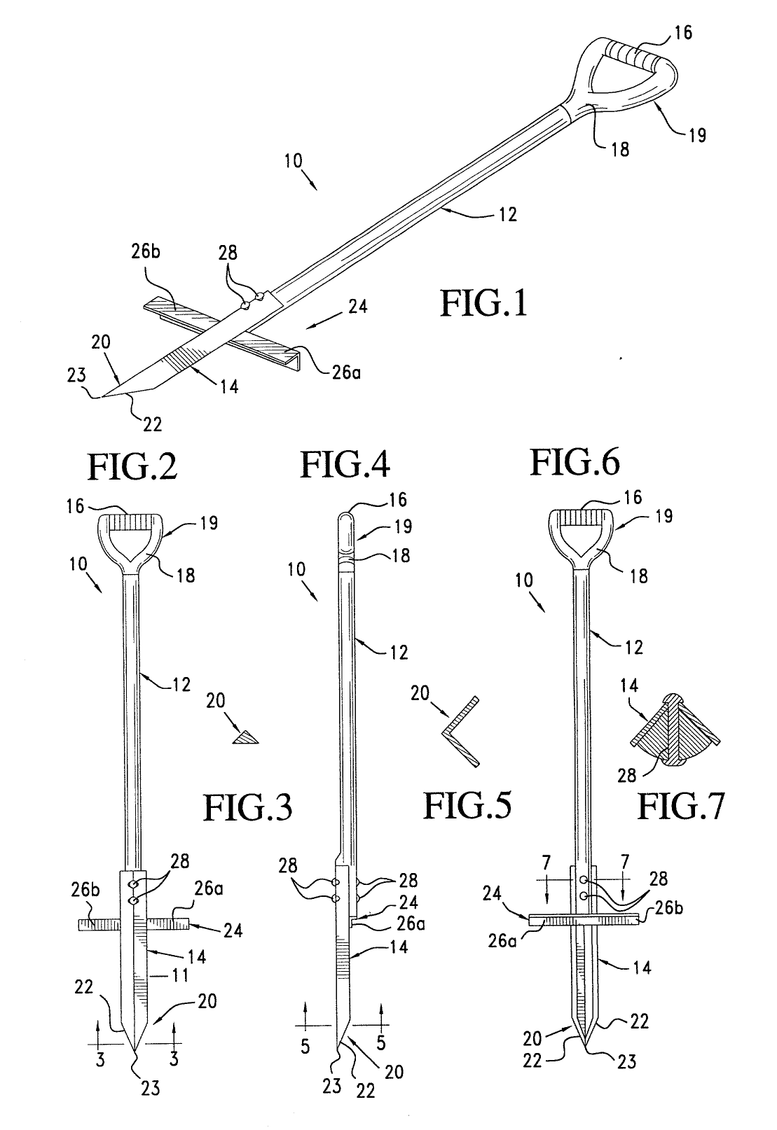

A plant removing or weeding device 10 according to the present invention is shown in FIGS. 1-7.

The plant removing or weeding device 10 includes a handle portion 12 connected to a blade portion 14 of the device 10. The handle portion 12 is provided with a handgrip portion 16 and a yoke portion 18 (e.g. D-shaped handle). This D-shaped handle is optional, and the handle portion 12 may end, alternatively, with a rounded end.

The blade portion 14 includes a tip portion 20 having a sharpened edge 22, or otherwise configured in a manner to facilitate forcing and penetrating the tip portion 20 into soil and then dividing the soil during use of the device 10. The blade portion 14 is provided with a cross-member 24 configured to function as a fulcrum and a set of foot pegs 26a and 26b.

The blade portion 14 is connected to the handle portion 12, for example, by a pair of fasteners 28 such as screws, rivets, studs, threaded fastener or other suitable type fastener (e.g. rivets as shown in FIG. 7). More specifically, the fasteners 28 can be machine screws cooperating with threaded holes tapped into the blade portion, or press fit therein. The fastener can be welded to the blade portion 14 to further secure the tip or end therein to prevent inadvertent loosening and subsequent disconnection thereof. Alternatively, a product such as LockTight can be used with threaded machine screws, again to prevent unwanted disassembly during long term use.

The handle portion 12 can be made of wood, metal, fiberglass, composite, or other suitable material. The handle 19 consisting of the handgrip 16 and yoke portion 18 can be a separate component connected to the end of the handle portion 12. More specifically, the yoke portion 18 can be made of metal and the handgrip 16 can be made of wood, or a plastic or rubber composition formed over a metal support connected to or formed as a portion of the metal yoke 18 to provide comfort during use, and potentially a better ergonomically designed device. Alternatively, the handle portion 12, handle 19 (i.e. handgrip 16 and yoke portion 18) can be made as a single integral piece, in particular a molded fiberglass handle or injection molded plastic unit.

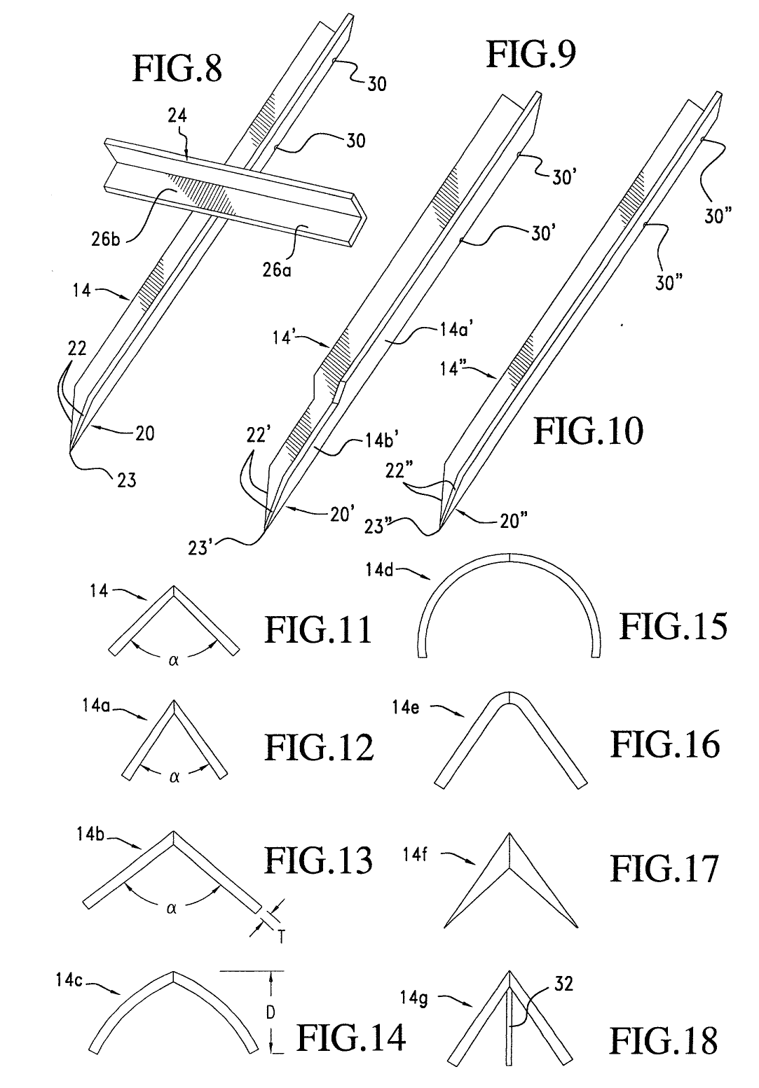

The blade portion 14 is preferably made of metal (e.g. mild steel, tempered steel, stainless steel, metal alloy, aluminum, aluminum alloy, or other suitable metal or metal alloy), plastic (e.g. fiberglass, Kevlar, boron fiber, carbon graphite fiber, plastic composite or other suitable plastic material), and/or composites of both metal and plastic configured and designed to provide suitable strength, durability and wear properties. In the embodiment shown in FIG. 8, the blade portion 14 has a substantially uniform transverse cross-sectional shape or profile along most of its length, except at the tip portion 20, which tapers down to a single point 23. Specifically, the transverse cross-sectional view of the blade portion 14, shown in FIG. 8, is a V-shaped section or profile in which the angle and the dimensions of the cross-sectional profile remain the same along the entire length of the blade portion 14, except for the tip portion 22.

In a preferred embodiment, the blade portion 14 and cross member 24 are made of a stock metal material that is made by rolling, forging, extruding, milling or other suitable metal forming or shaping technique. In particular, angle iron made of steel or steel alloy is highly favored, due to this type of material being readily available and somewhat inexpensive. For example, the blade member 14 is made of a piece of angle iron cut to length, and then the tip portion 20 is formed by cutting, grinding, milling, or other suitable operation to form the tip portion thereon. The through holes 30 can be drilled, and then optionally tapped and threaded to receive a bolt. The cross member 24 can be connected to the blade portion 14 by mechanical fasteners (e.g. bolts, rivets, or other suitable mechanical fasteners), brazing, welding, or other suitable metal fastening technique.

Another embodiment of the blade member 14′ is shown in FIG. 9. In this embodiment, the blade portion 14′ includes an upper portion 14a′ having a larger substantially uniform transverse cross-sectional profile (e.g. V-shaped profile), transitioning or tapering to a smaller lower blade section 14b′ (e.g. V-shaped profile) having the tip portion 22′. In this manner, the blade section 14a′ is further reinforced compared with the embodiment shown in FIG. 8, by having a dimensionally larger transverse cross-sectional profile (e.g. by utilizing a larger sized stock angle iron material). The transition from the larger upper blade section 14a′ to the smaller lower blade section 14b′ can be accomplished by cutting, grinding, milling or other suitable metal fabrication technique. This embodiment shown in FIG. 9 is to illustrate the concept that the transverse cross-sectional profile can change or vary in size along the length of the blade portion 14′. In addition, or alternatively, the shape of the transverse cross-sectional profile can vary along the length of the blade portion 14′ (e.g. changing from a wider angle V-shape profile to a less wide angle V-shaped profile from the bottom towards the top of the blade portion).

A further embodiment of the blade portion 14″ is shown in FIG. 10. The blade portion 14″ is substantially the same as that shown in FIG. 8, however, the cross member 24 is not provided. In this embodiment of the plant removing or weeding device according to the present invention, the device is not provided with any foot actuator and relies on the hands and arms of the user for forcing the blade portion 14″ into the soil and then dividing the soil at or near the root of the plant to be removed. As an alternative, a cross member and or foot peg(s) can be added to the handle portion 12 as a separate unit or made as an integral one piece unit (e.g. molded fiberglass handle with one or more foot pegs).

A variety of different transverse cross-sectional profiles of the blade portion 14 can be utilized in the plant removing or weeding device 10 according to the present invention. As shown in FIGS. 11-13, the angle ∝ can be varied from one embodiment to another. Preferably, the angle ∝ is in the range of sixty degrees (60°) to one-hundred twenty degrees (120°), more preferably in the range of seventy degrees (70°) to one-hundred ten degrees (110°), even more preferably in a range of eighty degrees (80°) to one-hundred degrees (100°), and most preferably ninety degrees (90°). Specifically, the wider the angle ∝ becomes, the blade portion has less structural strength against bending. As alternative transverse cross-sectional profiles of the blade portion, additional examples are shown in FIGS. 14-18. In all of these embodiments, the depth D (see FIG. 14) is large enough to provide substantial bending strength of the blade portion while allowing the tip of the blade portion to penetrate through and divide the soil. In all these embodiments, the bent configuration of the blade portion provides increased depth D to increase the bending strength of the blade portion.

Preferably, the tip portion of the blade portion is pointed, preferably in a center position thereof, to facilitate penetration of the tip portion into the ground or soil and reduce the amount of force required by the user to penetrate in and through the soil. In the embodiment shown in FIGS. 11 and 13, the wall thickness T remains substantially uniform across the width of the blade portion while remaining substantially flat in shape. In the embodiment shown in FIG. 14, the wall thickness remains substantially uniform, however, the wall portions are curved or bent to potentially further reinforce the blade portion. In the embodiment shown in FIG. 15, the blade portion has a substantially cylinder-shaped wall portion having a substantially uniform thickness. In the embodiment shown in FIG. 16, the transition angle between side-by-side blade portions is smoother or curved to reduce stress and strain at this location versus the sharp angle transitions shown in the embodiments of FIGS. 11-13. This may provide a more durable and longer wearing blade portion. In the embodiment shown in FIG. 17, the wall thickness tapers from a center portion to edge portions increasing the bending strength and potentially the durability and wear of the blade portion. In the embodiment shown in FIG. 18, an additional reinforcement rib 32 is provided to increase the bending strength of the blade portion.

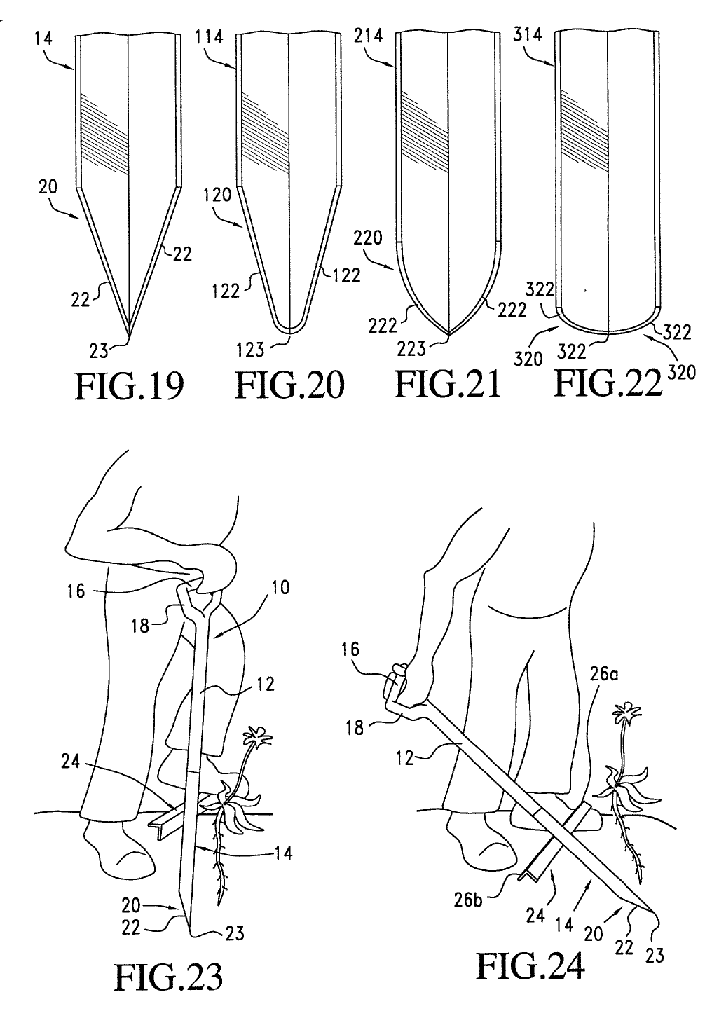

The tip portion 20 of the blade portion 14 is preferably tapered or has a narrow spade or spade-shaped configuration, as shown in the embodiments of FIGS. 19-22. However, it is to be noted that a blunt (e.g. transverse cut) tip portion of the blade portion can potentially work to some extent, however will require greater downward force by the user to penetrate and divide the soil. In the embodiment shown in FIG. 19, the tip portion 20 is sharpened to form tapering edges 22 and sharpened point 23. In the embodiment shown in FIG. 20, the point 123 is somewhat rounded to potentially make the tip more durable and resistant to wear. In the embodiment shown in FIG. 21, the edge portions 222 are curved, again to potentially increase the durability and wear of these edges. In the embodiment shown in FIG. 22, the edges 322 are rounded to simplify fabrication of the blade portion. In any event, the tip portion of the blade portion is preferably configured and designed to reduce the amount of force necessary by the user to penetrate and divide the soil while providing a durable and wear proof tip portion.

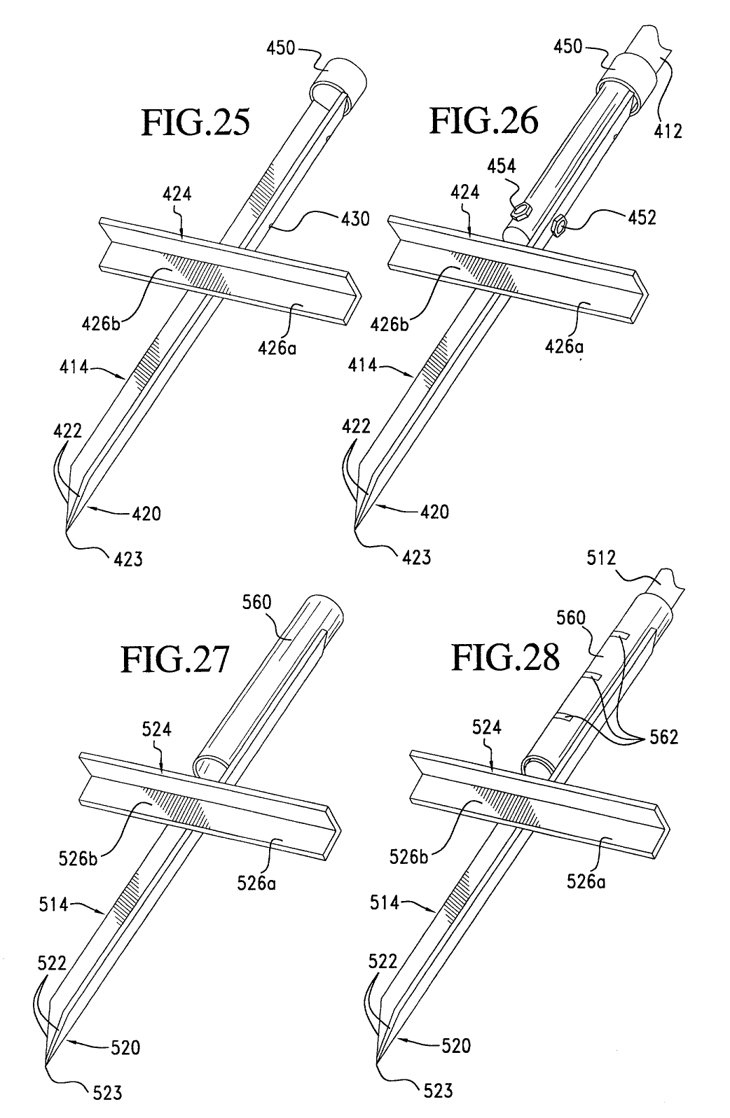

In use, as shown in FIGS. 23 and 24, the user drives the blade portion 14 of the device 10 into the soil adjacent to the root of the plant to be removed by pressing down, using the body weight of the operator's foot on the crossbar, and stabilizing with one hand, assisted by one or both feet depending on the hardness of the soil. It is noted that the device 10 is oriented in a substantially vertical position as shown. After the cross member 24 makes contact with the surface of the soil, the user continues to force the blade downwardly by foot pressure while pulling back on the handle portion 12 as shown in FIG. 24 causing the blade portion 14 to pivot at the fulcrum upwardly along with the root of the plant to be removed. This action further breaks up the soil at and around the root while elevating the plant from the soil. The blade portion 14 can be further manipulated at or around the root of the plant by twisting the tool ninety degrees (90°) and using an end of the cross member 24 so as to act as a fulcrum to lift the loosened plant with the edge of the blade portion 14 clear of the ground to insure substantially full removal of the whole plant.

Another preferred embodiment of the blade portion 414 according to the present invention is shown in FIGS. 25 and 26.

In this preferred embodiment, a metal ring 450 is connected (e.g. by welding) to an upper portion of the blade portion 414. The metal ring, for example, can be made from a section of metal pipe or tubing such as steel, galvanized steel or stainless steel tubing. As shown in FIG. 26, the handle portion 412 fits through the metal ring 450, and is secured to the blade portion by bolt 452 and nut 454. Specifically, the bolt fits through the through hole 430 (see FIG. 25) and a through hole through the lower end of the handle portion 412, and is secured in place with a nut 454, preferably a nut having a lock washer or integral locking ring configuration to prevent inadvertent loosening during use. Preferably, the metal ring 450 has an inner diameter approximately the size of the outer diameter of the handle portion 412. The inner diameter of the metal ring 450 can be slightly less than the outer diameter of the handle portion 412 to provide a slight interference fit, or alternatively, can be the same size or slightly larger to allow easy and quick disassembly and replacement of the handle portion 412 in the event of wear, damage or breakage of the handle portion 412. The wall thickness of the metal ring 450 is sufficient to withstand barrel or loop type stresses exerted by the handle portion 412 on the blade portion 414 during use of the plant removing or weeding device. This particular embodiment eliminates one (1) fastener compared with the embodiment shown in FIGS. 16, and provides a stronger connection between the handle portion 412 and 414 compared with that of the embodiment shown in FIGS. 1-6. Again, the handle portion 412 can be quickly disassembled and replaced by loosening and undoing only a single fastener (i.e. bolt 452 and nut 454).

The handle portion 412 is assembled onto the blade portion 414 by sliding the bottom end of the handle portion 412 through the metal ring 450 until the bottom end of the handle portion 412 makes contact with an upper edge of the cross member 424. Then the bolt 452 is pressed through the through hole 430 of the blade portion 414, then through the through hole in the bottom end of the handle portion 412, and then the locking nut 454 is connected or threaded thereto. The V-shaped transverse cross-sectional profile of the blade portion 414 partially surrounds or cradles a length of the lower portion of the handle portion 412 further reinforcing the connection between the handle portion 412 and the blade portion 414.

A further embodiment of the blade portion 514 according to the present invention is shown in FIGS. 27 and 28.

In this preferred embodiment, a sleeve 560 is connected (e.g. by welding) to an upper portion of the blade portion 514. The sleeve 560 can be made from a section of metal pipe or tubing. The handle portion 512 is connected to the blade portion 514 by inserting a lower end of the handle portion 512 into the sleeve 560 until the lower end of the handle portion 512 makes contact with the upper edge of the cross member 524. Then, the sleeve 560 is crimped at locations 562 (see FIG. 28) along the length of the sleeve 560. Alternative to crimping, or in addition, one or more metal fasteners such as a bolt and nut or rivet extends through the sleeve 560 and lower end of the handle portion 512 to accommodate same. As shown in embodiment of FIGS. 27 and 28, the sleeve 560 is partially surrounded or cradled by an upper end of the blade portion 514 to enhance the strength of the connection between the handle portion 512 and blade portion 514. Alternatively, the upper end of the blade portion 514 can be eliminated and the sleeve 560 can be directly welded to the upper edge of the cross member 524. However, the embodiment shown will provide a stronger connection between the handle portion 512 and blade portion 514 versus the proposed alternative embodiment.

What is claimed is:

1. A plant removing or weeding device configured for removing plants, weeds or other vegetation from soil, said device comprising:
a handle portion:
an elongated-shaped blade portion connected to said handle portion, said blade portion being substantially bent along a longitudinal axis of said blade portion, said blade portion having a spade. tip portion,
whereby, said blade portion is driven into and divides the soil adjacent to a root of the plant or weed to be removed, and then the handle portion is pulled towards the user and pushed downwardly to pivot the blade portion upwardly breaking the soil and lifting the plant or weed including the root out of the soil for substantially full removal thereof.

2. A device according to claim 1, wherein said elongated blade is a reverse bent blade configured to open in a direction away from a plant being removed.

3. A device according to claim 1, wherein said bent blade is defined by a first elongated blade portion connected to a second elongated blade portion by a curved or rounded transition blade portion.

4. A device according to claim 1, wherein said bent blade is defined by at least a first elongated blade portion connected to at least a second elongated blade portion by at least one angular blade transition portions.

5. A device according to claim 1, wherein said bent blade is defined by two elongated bladed portions set at an angle.

6. A device according to claim 1, wherein said bent blade includes three or more elongated blade portions set at angles relative to each other.

7. A device according to claim 5, wherein said angle is preferably in a range of sixty degrees (60°) to one-hundred twenty degrees (120°).

8. A device according to claim 6, wherein said angle is more preferably in a range of seventy degrees (70°) to one-hundred ten degrees (1100°).

9. A device according to claim 7, wherein said angle is even more preferably in a range of eighty degrees (80°) to one-hundred degrees (100°).

10. A device according to claim 8, wherein said angle is most preferably ninety degrees (90°).

11. A device according to claim 1, wherein said blade is provided with a rounded spade tip portion.

12. A device according to claim 1, wherein said blade is provided with pointed spade tip portion.

13. A device according to claim 1, wherein said blade is provided with a sharpened spade tip portion.

14. A device according to claim 1, wherein said blade portion is defined by a first blade portion connected along one edge to a second blade portion, said first blade portion being located at an angle relative to said second blade portion.

15. A device according to claim 14, wherein said blade portion is made for a single piece of material.

16. A device according to claim 14, wherein said first blade portion and second blade portion are separate pieces of material connected together longitudinally.

17. A device according to claim 15, wherein said blade portion is made from a piece of angle iron.

18. A device according to claim 1, including a foot actuator connected at a right angle to the device, said foot actuator configured to allow a user to apply downward digging force to said device using their foot or feet.

19. A device according to claim 18, wherein said foot actuator is connected to said blade portion.

20. A device according to claim 19, wherein said elongated-shaped blade portion is made from a piece of angle iron and said foot actuator is made from a piece of angle iron and welded to said blade portion and oriented transversely at a right angle relative to a length direction of said elongated-shaped blade portion.

21. A device according to claim 1, wherein said elongated blade portion is configured to have a V-shaped transverse cross-sectional shape.

22. A device according to claim 1, including a fulcrum connected to said device, said fulcrum configured to contact the ground and provide a mechanical advantage between said handle portion and said blade portion.

23. A device according to claim 22, wherein said fulcrum is configured to also function as a foot actuator, said foot actuator configured to allow a user to apply downward digging force to said device using their foot or feet.

24. A device according to claim 23, wherein said fulcrum is a transverse member connected to said blade portion.

25. A plant weeding device, comprising:
a handle portion:
an elongated-shaped reverse bent blade portion connected to said handle portion, said blade portion bent at an angle substantially along a longitudinal axis of said blade portion, said blade portion having a spade tip portion,
whereby, said blade portion is driven into and divides the soil adjacent to a root of the plant or weed to be removed, and then the handle portion is pulled towards the user and pushed downwardly to pivot the blade portion upwardly breaking the soil and lifting the plant or weed including the root out of the soil for substantially full removal thereof.
